(19) United States
(12) Patent Application Publication
(10) Pub. No.: US 2015/0296348 A1
(43) Pub. Date: Oct. 15, 2015

(54) POLLING BETWEEN WIRELESS DEVICE AND VEHICLE TRANSCEIVERS

(71) Applicant: Lear Corporation, Southfield, MI (US)

(72) Inventor: Riad GHABRA, Northville, MI (US)

(21) Appl. No.: 14/674,212

(22) Filed: Mar. 31, 2015

Related U.S. Application Data
(60) Provisional application No. 61/979,188, filed on Apr. 14, 2014.

(51) Int. Cl. H04W 4/04; H04W 52/02

(52) U.S. Cl. CPC H04W 4/046; H04W 52/0209

(57) ABSTRACT

Polling methods and systems are described to allow a wireless device to establish communication with a base, e.g., a vehicle, in an efficient manner. The polling signal includes a plurality of time separated, polling transmission signals and a single receive time period. The polling transmission signals are separated by a non-transmission time period that is greater than a transmission time of the time separated transmission signals. The polling scheme can be repeated the polling signal until a poll response signal from the base is received. Energy savings for the wireless device are provided by limiting the number of receive actions and time periods in the wireless device.

The present application claims the benefit under 35 U.S.C. §119(e) to U.S. Patent Application No. 61/979,188, filed on 14 Apr. 2014, which is hereby incorporated by reference.

### TECHNICAL FIELD

Embodiments of the present disclosure generally provide for an apparatus and method for polling between a wireless device and a vehicle for initiating communication.

### BACKGROUND

It is known to detect the location of a wireless device in relation to a vehicle. One implementation for detecting the location of the wireless device in relation to the vehicle is set forth directly below.

U.S. Patent Publication No. 2010/0076622 to Dickerhoof et al. provides a system for determining the location of a wireless device with respect to a vehicle. The system comprises a plurality of antennas positioned about the vehicle for receiving a wireless signal from the wireless device. The wireless signal corresponds to at least one of a command and status related to a predetermined vehicle operation. The system further comprises a controller operably coupled to each antenna. The controller is configured to generate a location signal indicative of the location of the wireless device based on the arrival time of the wireless signal at one or more antennas of the plurality of antennas and to control the operation of the predetermined vehicle operation based on the location signal.

### BRIEF DESCRIPTION OF THE DRAWINGS

The embodiments of the present disclosure are pointed out with particularity. However, other features of the various embodiments will become more apparent and will be best understood by referring to the following detailed description in conjunction with the accompany drawings in which:

FIG. 1 depicts an apparatus for detecting a location of a wireless device in accordance with one embodiment;

FIG. 2 depicts a detailed schematic view of the wireless device, the main base station and the auxiliary base station in accordance with one embodiment;

FIG. 3 depicts a method for detecting the location of the wireless device in accordance with one embodiment;

FIG. 4 depicts a first distance, a second distance, and a third distance of the wireless device from the vehicle in accordance with one embodiment;

FIG. 5 depicts the manner in which the wireless device polls for a signal from the vehicle in accordance with one embodiment;

FIG. 6 depicts an enlarged view of a portion of FIG. 5;

FIG. 7 depicts the manner in which the vehicle monitors for the polling signal;

FIG. 8 depicts the manner in which the wireless device and the vehicle communicate passively in accordance with one embodiment; and

FIG. 9 depicts the manner in which the wireless device communicates with the vehicle in response to an operator command, in accordance with one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, RAM, ROM, EPROM, EEPROM, or other suitable variants thereof) and software which co-act with one another to perform any number of the operation(s) as disclosed herein.

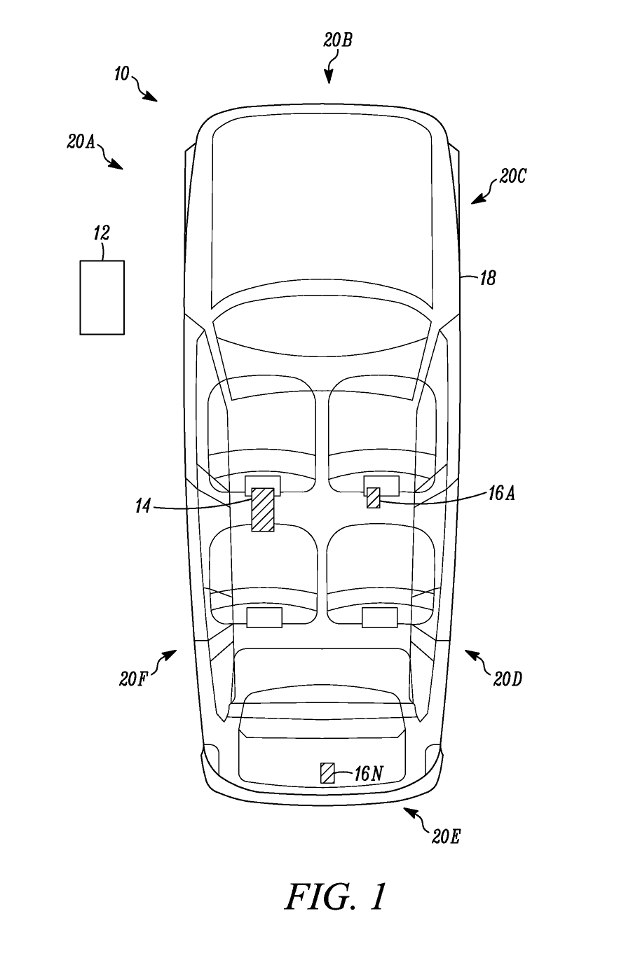

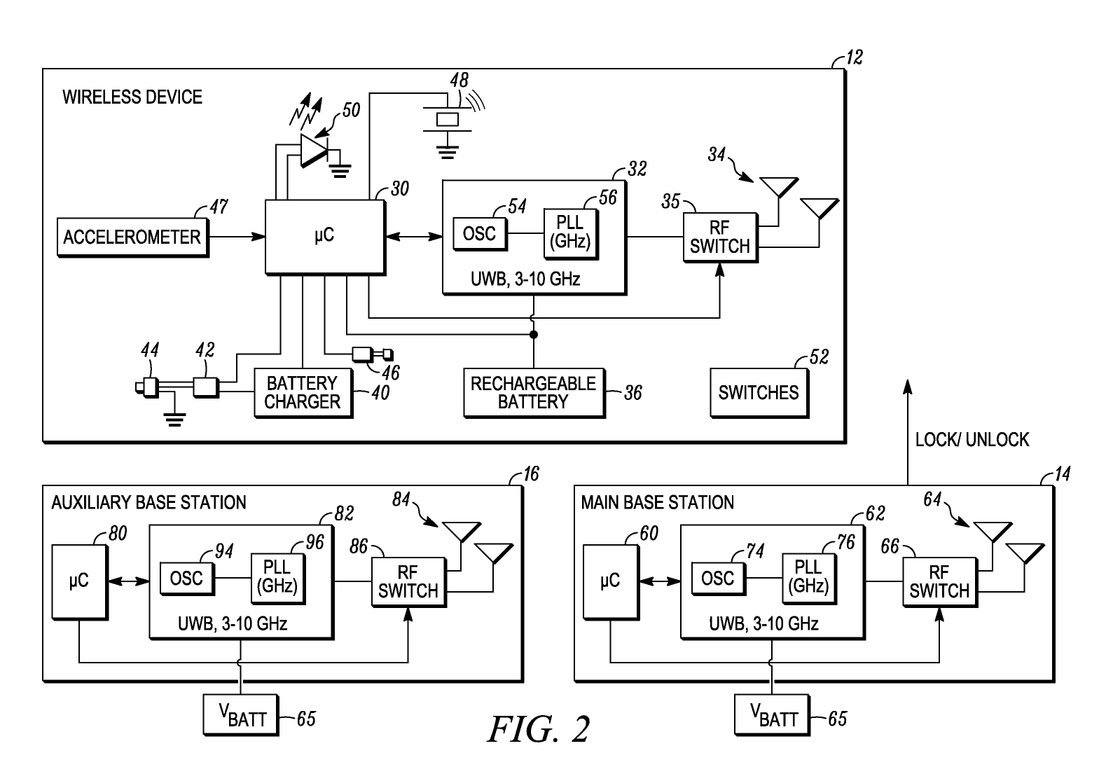

FIG. 1 depicts an apparatus 10 for detecting a location of a wireless device 12 in accordance with one embodiment. The wireless device 12 may be implemented as a key fob or other suitable device that is used to gain entry into a vehicle 18. The apparatus 10 comprises a main base station 14 and at least two auxiliary base stations 16a-16n (“16”) for detecting the location of the wireless device 12 with respect to a vehicle 18. For example, the main base station 14 and the auxiliary base stations 16 each include a transmitter/receiver (“transceiver”) for wirelessly transmitting/receiving signals to/from the wireless device 12. Each of base station 14 and auxiliary base stations 16 may be referred to as vehicle-based electronic modules. The transmitter/receiver for each of the wireless device 12, the main base station 14, and the auxiliary device 16 will be discussed in more detail in connection with FIG. 2.

The main base station 14 generally includes additional circuitry to lock and unlock the vehicle 18 in response to command signals as provided by the wireless device 12. The apparatus 10 may perform a passive entry passive start (PEPS) function in which the main base station 14 may unlock the vehicle 18 in response to determining that the wireless device 12 is positioned in a corresponding zone (or quadrant) 20a-20n (i.e., front driver side zone, vehicle front zone, front passenger side zone, rear passenger side zone, vehicle rear zone, and rear driver side zone, respectively) about the vehicle 18. For example, the zones 20 generally correspond to predetermined authorized locations about the vehicle 18 (e.g., interior to and exterior to the vehicle 18) such that if the wireless device 12 is detected to be in one of such zones 20, then the main base station 14 may automatically unlock the vehicle (or door) proximate to zone 20 in which the wireless device 12 is detected to be within and enable the user to start the vehicle.

The apparatus 10 may utilize remote keyless operation in addition to the PEPS function. For example, the main base station 14 may perform a desired operation (e.g., lock, unlock, lift gate release, remote start, etc.) with the vehicle 18 in the event the wireless device 12 transmits a command indicative of the desired operation while within the authorized zone 20. In addition, the apparatus 10 may be used to perform a car finder application.

In general, the main base station 14, the auxiliary base stations 16, and the wireless device 12 engage in a series of signal exchanges with one another and utilize a time of flight (TOF) implementation to determine a distance of the wireless device 12 from the vehicle 18. Thereafter, the main base station 14 may employ trilateration to locate the actual zone 20 the wireless device 12 is positioned within. At least four distance determinations are needed to determine a 3-dimensional location of the wireless device 12. The use of trilateration enables the main base station 14 the ability to locate where the wireless device 12 is located relative to the vehicle. This information (e.g., which zone 20 the wireless device 12 is positioned within) coupled with distance information as ascertained by utilizing TOF enables the main base station 14 to locate with increased levels of accuracy the location of the wireless device 12 in relation to the vehicle 18. The apparatus 10 may be arranged to precisely determine the location of the wireless device 12 about or within the vehicle 18 as opposed to conventional systems in which perhaps only the transponder may be located at various sides of the vehicle with lesser degrees of accuracy.

For example, the main base station 14 may determine that the wireless device 12 is positioned at a distance of three meters away from the vehicle 18 and that the wireless device 12 is positioned in the zone 20a which corresponds to a driver side zone. While it is noted that the location of the wireless device 12 may be ascertained via the TOF and trilateration, it is recognized that the aspects noted herein with respect to locating the wireless device 12 may be applicable to other vehicle functions such as, but not limited to, tire pressure monitoring, where wireless device 12 may be one of four wheel-mounted tire pressure sensors. These aspects and others will be discussed in more detail below. While utilizing the TOF, it is recognized that the main base station 14 and the auxiliary base stations 16 may be positioned at predetermined locations in the vehicle 18 for transmitting and receiving signals to and from the wireless device 12.

FIG. 2 depicts a detailed schematic view of the wireless device 12, the main base station 14, and an auxiliary base stations unit 16 in accordance with one embodiment. The wireless device 12 includes a microcontroller 30, a transmitter/receiver (“transceiver”) 32, and at least one antenna 34. The microcontroller 30 is operably coupled to the transceiver 32 and the antenna 34 for transmitting and receiving signals to/from the main base station 14 and the auxiliary base stations 16. A radio frequency (RF) switch 35 is operably coupled to the antennas 34 for coupling the same to the transceiver 32. A multiple antenna 34 implementation may provide for antenna diversity which may aid with respect to radio frequency multi-paths. The use of the RF switch 35 and multiple antennas are optional. For example, a single antenna 34 may be used for transmitting and receiving signal to and from the wireless device 12.

A rechargeable battery 36 powers the microcontroller 30 and the transceiver 32. A battery charger circuit 40 receives power from a charger connector 42 that is operably coupled to an external power supply (not shown). The battery charger circuit 40 may condition the incoming power from the external power supply to ensure that it is suitable for storage on the rechargeable battery 36. It is recognized that the battery charger circuit 40 and the battery 36 may wirelessly receive power from an external device for charging the same. Battery 36 may also be nonrechargable and/or replaceable, depending upon the precise battery capacity and electrical loading involved.

The battery charger 40 may indicate to the microcontroller 30 when the battery 36 is being recharged and/or the charge state of the battery 36 according to one or more embodiments. A first lighting indicator 44 may be positioned about the charger connector 42 and operably coupled to the microcontroller 30 to provide charge status of the battery 36 to a user. A vibrating motor 46 may be operably coupled to the microcontroller 30 and is arranged to provide a haptic feedback. An accelerometer 47 is operably coupled to the microcontroller 30 for detecting the motion of the wireless device 12. For example, the wireless device 12 may be arranged to initiate the transmission of data in response to determining that it is moving. A piezo-sounder 48 may also be operably coupled to the microcontroller 30 and arranged to provide an audio based feedback. A second lighting indicator 50 may also be operably coupled to the microcontroller 30 and arranged to provide a visual feedback. A plurality of switches 52 are positioned on the wireless device 12, each for transmitting a command to the vehicle 18 such that a desired operation is performed (e.g., lock, unlock, lift gate release, remote start, etc.).

The transceiver 32 is generally configured to operate at an operating frequency of between about 2.4-10 GHz or 3.0-10 GHz. In general, by operating the transceiver 32 at an operating frequency of between about 2.4-10 GHz or 3-10 GHz, this condition may enable the wireless device 12, and the auxiliary base station 16 to determine a distance thereof with respect to the vehicle within a high degree of accuracy in the event the wireless device 12 engages in communication with the vehicle 18 to provide its distance from the vehicle 18. The operating frequency aspect will be discussed in more detail below. The transceiver 32 generally includes an oscillator 54 and a phase locked loop (PLL) 56 for enabling the transceiver 32 to operate at the frequency of between about 2.4-10 GHz or 3.0-10 GHz. By enabling the transceiver 32 to operate at an operating frequency of between about 2.4-10 GHz or 3.0 and 10.0 GHz, such a condition also enables the transceiver 32 to transmit and receive signals at an ultra-wide band (UWB) bandwidth of at least 500 MHz.

The main base station 14 generally includes a microcontroller 60, a transceiver 62, and at least one antenna 64. An RF switch 66 is operably coupled to the microcontroller 60 and to the antenna 64. The RF switch 66 is operably coupled to the antennas 64 for coupling the same to the transceiver 62. A multiple antenna 64 implementation may provide for antenna diversity which may aid with respect to RF multi-paths. It is also contemplated that a single antenna 64 may be used for transmitting and receiving signal to and from the wireless device 12 without the need for the RF switch 66. The microcontroller 60 is operably coupled to the transceiver 62 and the antenna 64 for transmitting and receiving signals to/from the wireless device 12 and the auxiliary base station 16. A power source 65 in the vehicle 18 powers the microcontroller 60 and the transceiver 62. The main base station 14 further includes circuitry (not shown) for performing locking/unlocking vehicle doors and/or a liftgate/trunk and for performing remote start operation.

The transceiver 62 is also generally configured to operate at the operating frequency of between 3-10 GHz. By operating the transceiver 62 at an operating frequency of between 3-10, at the operating frequency of between 3-10 GHz, this condition may enable the main base station 14 to determine the distance of the wireless device 12 with respect to the vehicle within a high degree of accuracy when it engages in communication with the wireless device 12. This will be discussed in more detail below. The transceiver 62 generally includes an oscillator 74 and a PLL 76 for enabling the transceiver 62 to operate at the frequency of between 3-10 GHz. The transceiver 62 is also configured to transmit and receive signals at the UWB bandwidth of at least 500 MHz. By enabling the transceiver 62 to operate at the operating frequency of between 3 and 10 GHz, such a condition also enables the transceiver 62 to transmit and receive signals at the UWB range. Alternatively, in one or more embodiments, the main base station 14 does not include the transceiver 62 for communicating with the wireless device 12.

The auxiliary base station 16 generally includes a microcontroller 80, a transceiver 82, and at least one antenna 84. An RF switch 86 is operably coupled to the microcontroller 60 and to the antenna 64. The RF switch 86 and multi-antenna 84 implementation is optional for the reasons noted above. The microcontroller 80 is operably coupled to the transceiver 82 and the antenna 84 for transmitting and receiving signals to/from the wireless device 12 and main base station 14. The power source 65 in the vehicle 18 powers the microcontroller 80 and the transceiver 82.

The transceiver 82 is also generally configured to operate at the operating frequency of between 3-10 GHz. By operating the transceiver 82 at an operating frequency of between 3-10 GHz, this condition may enable the auxiliary base station 16 to determine the distance of the wireless device 12 with respect to the vehicle within a high degree of accuracy when it engages in communication with the wireless device 12. This will be discussed in more detail below. The transceiver 82 generally includes an oscillator 94 and a PLL 96 for enabling the transceiver 62 to operate at the frequency of between 3-10 GHz. The transceiver 82 is also configured to transmit and receive signals at the UWB bandwidth of at least 500 MHz. It is recognized that the second auxiliary base station 16n can be similar to the auxiliary base station 16a as described above and can include similar components and provide, in relevant part, similar functionality.

As the wireless device 12, the main base station 14, and the auxiliary base stations 16 are each arranged to transmit and receive data within the UWB bandwidth of at least 500 MHz, this aspect may place large current consumption requirements on such devices. For example, by operating in the UWB bandwidth range, such a condition yields a wide frequency spectrum and a high time resolution which improves ranging accuracy. Power consumption is less of an issue for the main base station 14 and the auxiliary base stations 16, as compared to the wireless device 12, since such base stations 14, 16 are powered from the power source 65 in the vehicle. Generally, portable devices, such as the wireless device 12, are equipped with a standalone battery. In the event the standalone battery is implemented in connection with the wireless device 12 that transmits/receives data in the UWB bandwidth range, the battery may be depleted rather quickly. To account for this condition, the wireless device 12 can include the rechargeable battery 36 and the battery charger circuit 40, along with the charger connector 42 (or wireless charging implementation) such that the battery 36 can be recharged as needed to support the power demands used in connection with transmitting/receiving information in the UWB bandwidth range.

In general, the larger the operating frequency of the transceivers 32, 62, and 82; the larger the bandwidth that such transceivers 32, 62, and 82 can transmit and receive information. Such a large bandwidth (i.e., in the UWB bandwidth) may improve noise immunity and improve signal propagation. This may also improve the accuracy in determining the distance of the wireless device 12 since UWB bandwidth allows a more reliable signal transmission. As noted above, an operating frequency of 3-10 GHz enables the transceivers 32, 62, and 82 to transmit and receive data in the UWB range. The utilization of the UWB bandwidth for the wireless device 12, the main base station 14, and the auxiliary base stations 16 may provide for high ranging (or positioning) accuracy and high-speed data communications. Transmission in the UWB spectrum may provide for robust wireless performance against jamming. This may also provide for an anti-relay attack countermeasure and the proper resolution to measure within, for example, a few centimeters of resolution.

The implementation of UWB in the wireless device 12, the main base station 14, and the auxiliary base station 16 is generally suitable for TOF applications.

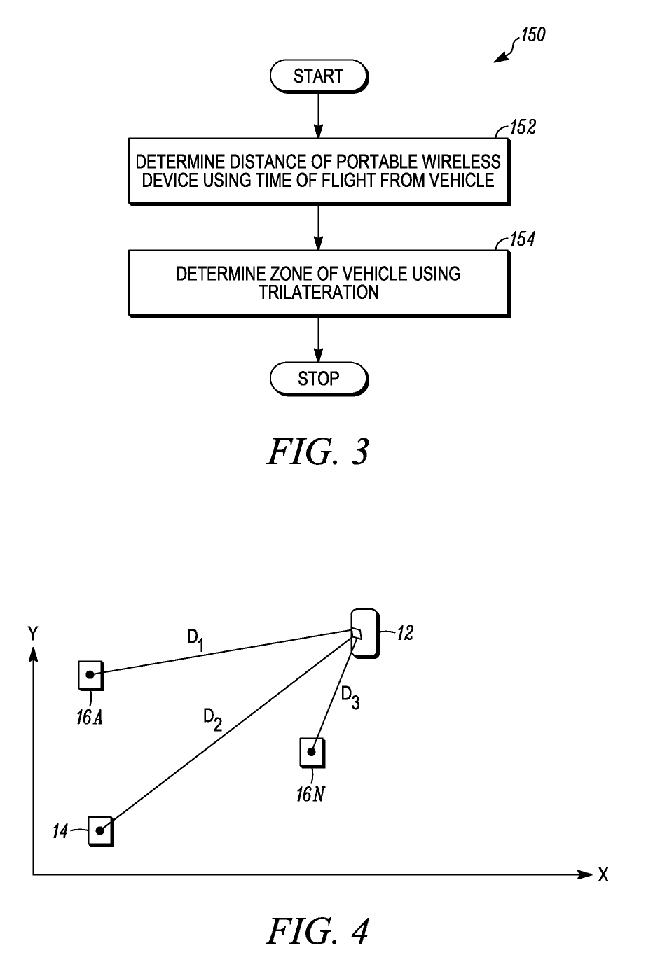

FIG. 3 depicts a method 150 for detecting the location of the wireless device 12 in accordance with one embodiment.

In operation 152, the apparatus 10 determines the distance of the wireless device 12 using TOF measurements. TOF is known to be based on the time required for a wireless signal to travel from a first location to a second location, in which the time is generally indicative of the distance between the first location and the second location. This can be extended to apply to the apparatus 10. For example, the apparatus 10 may measure the time required for data (or information) to be transmitted from the wireless device 12 and to one or more of the main base station 14 and the auxiliary base station 16 and determine the distance in which the wireless device 12 is located from the vehicle 18 based on the time measurements.

To begin the process of determining the location of the wireless device 12 with respect to the vehicle 18, the wireless device 12 may transmit a polling signal if it proximate to the vehicle 18, for the vehicle 18 to determine the location of the wireless device 12. In this case, the wireless device 12 may periodically transmit the polling signal in response to detecting a motion thereof. The accelerometer 47 within the wireless device 12 may transmit a motion signal to the microcontroller 30 that indicates that the wireless device 12 is in motion. Any one of the main base station 14 and the auxiliary base stations 16 may receive the polling signal and respond back to the wireless device 12. For example, assuming, the main base station 14 receives the polling signal, the main base station 14 may then transmit a first signal and include a first time stamp therein. The first signal is transmitted to the wireless device 12. The wireless device 12 receives the first signal with the first time stamp and generates a second signal including a second time stamp corresponding to the time it received the first signal. The wireless device 12 transmits the second signal back to the main base station 14. The main base station 14 may then determine a round trip time based on the first time stamp and on the second time stamp. The round trip time may correspond to the time measurement which is indicative of the distance between wireless device 12 and the main base station 14. This exchange may be repeated any number of times such that any number of time measurements may be ascertained. Multiple measurements may improve the accuracy of the distance determination. In one or more embodiments, the main base station 14 does not include an internal transceiver 32 and does not determine a distance between itself and the wireless device 12.

Polling communication between the wireless device 12 and the base stations 14, 16 involves RF communication (i.e., between 3-10 GHz). In one or more embodiments the wireless device 12 and the base stations 14, 16 may also communicate using a low frequency (LF) communication (i.e., 125 kHz) during a backup mode. In an example, the backup mode is triggered when the battery 36 of the wireless device 12 is discharged to a lower power state, e.g., when the battery is discharged to a near depletion and preserving electrical energy in the battery is needed to extend the operational time of the wireless device 12. In the backup mode, the wireless device 12 changes its communication frequency using settings in the controller in the wireless device 12. The vehicle's base stations 14, 16 will also listen at the LF band for communications from the wireless device when in the wireless device is in the backup mode.

After exchanging signals between the wireless device 12 and the main base station 14 to determine the first distance D1, the wireless device 12 and the auxiliary base station 16a may engage in a similar exchange (e.g., insertion of time stamps) such that the second distance D2 is obtained which corresponds to the distance between the wireless device 12 and the auxiliary base station 16a. Again, multiple signal exchanges with multiple time stamps may be used to improve the accuracy of the distance determination.

After exchanging signals between the wireless device 12 and the auxiliary base station 16a to determine the second distance D2, the wireless device 12 and the auxiliary base station 16n may engage in a similar exchange (e.g., insertion of time stamps) such that the third distance D3 is obtained which corresponds to the distance between the wireless device 12 and the auxiliary base station 16n. Multiple signal exchanges with multiple time stamps may be used to improve the accuracy of the distance determination.

It is to be noted that the above signal exchange between the wireless device 12, the main base station 14, and auxiliary base stations 16 may take into account delay times generally associated with electronics in the wireless device 12 and in the base stations 14, 16 for providing the time measurements.

Once the auxiliary base stations 16a and 16n determine the second distance D2 and the third distance D3, each of the auxiliary base stations 16a and 16n may wirelessly transmit such data to the main base station 14. The main base station 14 uses the distances D1, D2, and D3 to determine which zone 20 the wireless device 12 is positioned in. This will be discussed in more detail below. The utilization of the operating frequency at between 3-10 GHz and the transmission/reception of information within the UWB bandwidth generally enables the wireless device 12, the main base station 14, and the auxiliary base stations 16 to process the time measurement with a high degree of resolution so that the main base station 14 and the auxiliary base stations 16 each provide a corresponding distance (e.g., D1, D2, and D3) within a high degree of resolution.

Alternate embodiments contemplate that the wireless device 12 itself, may provide a distance reading in a similar manner to that stated above while engaging in TOF measurements with the main base station 14 and/or the auxiliary base stations 16 while also operating at the operating frequency to determine a distance accuracy value. In this case, the wireless device 12 may provide a distance reading to the main base station 14. The main base station 14 may then use the distance reading from the wireless device 12 and those from the auxiliary base station(s) 16 to determine the location of the wireless device 12.

FIG. 4 generally illustrates the distances (e.g., D1, D2, and D3) as determined by the main base station 14, the auxiliary base station 16a, and the auxiliary base station 16n. It is recognized that at least three reference points (or three distance measurements (e.g., D1, D2, and D3)) may be needed for the main base station 14 to ascertain which zone 20a-20n the wireless device is located in when the main base station 14 performs trilateration.

In operation 154, the main base station 14 employs trilateration to determine the zone 20a-20n in which the wireless device 12 is positioned. As noted above, the apparatus 10 may use the TOF implementation to ascertain the distance (e.g., D1, D2, D3) of the wireless device 12 from the vehicle 18.

Generally, trilateration employs determining an absolute or relative location of points via measurement of distance by examining the geometry of circles, spheres, or triangles. An example of trilateration is set forth in “Intersection of two circles,” Paul Bourke, April 1997 and in “Trilateration,” Alan Kaminsky, Mar. 8, 2007. For example, the main base station 14 may use the three distances D1, D2, and D3 and utilize trilateration to find coordinates (e.g., zone) that the wireless device 12 is positioned in. The coordinates of the wireless device 12 may correspond to a point in the x, y, z axis. Once the final coordinates are ascertained, the main base station 14 may perform a predetermined operation based on the final coordinates of the wireless device 12. For example, the main base station 14 may unlock a door or liftgate. In another example, the main base station 14 may send a message over a communication bus to enable a remote start operation. Any number of vehicle operations may be performed once the final coordinates are ascertained.

Alternate embodiments contemplate that the wireless device 12 may also perform trilateration instead of the main base station 14. For example, as noted above, the wireless device 12 may use the distance reading that it has calculated in addition to the distance readings (e.g., D1, D2, and/or D3) from the main base station 14, the auxiliary base station 16a, and/or the auxiliary base station 16n and perform the trilateration with these readings to determine the zone 20 in which the wireless device 12 is positioned. This information can be sent to the main base station 14.

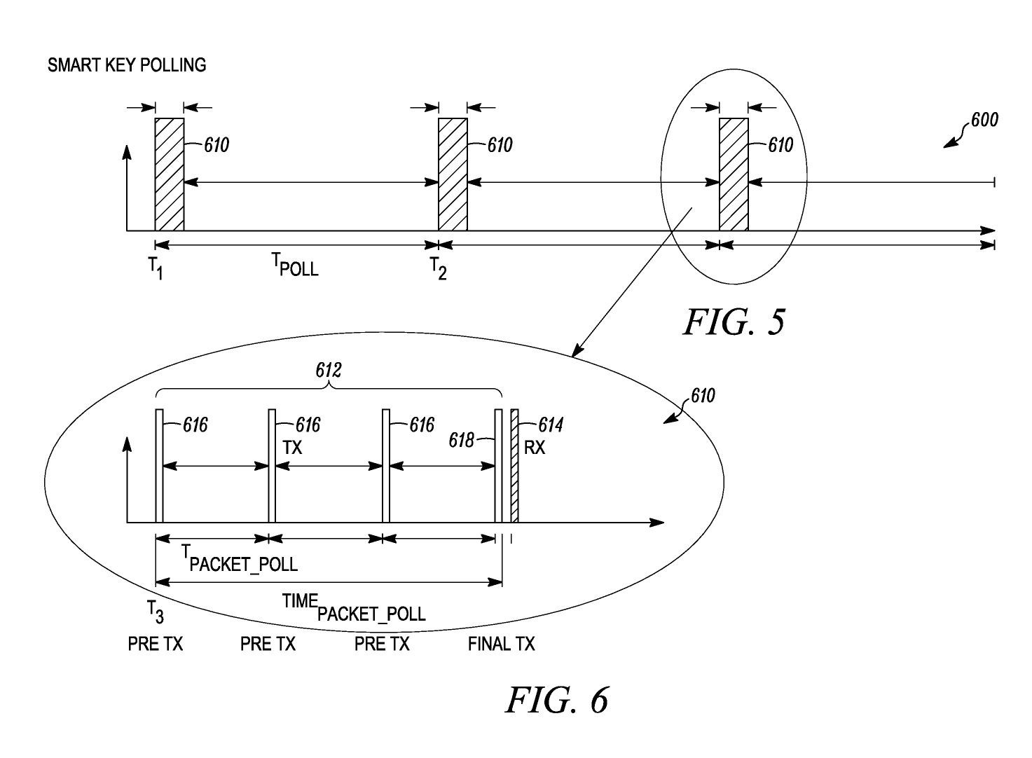

FIG. 5 depicts the manner in which the wireless device 12 polls for a signal from one or more of the base stations (e.g., the main base station 14 and the auxiliary base stations 16) in accordance with one or more embodiments, and is generally referenced by numeral 600. The polling operation 600 of the wireless device 12 occurs automatically and without user intervention (e.g., without the user pressing a button on the wireless device 12 or the like). The wireless device 12 transmits data packets 610 at a polling period (Tₚₒₗₗ). The polling period Tₚₒₗₗ can be predetermined in an example. The period Tₚₒₗₗ can be set after the device is paired with the vehicle. Each brand or model of vehicle can have its own period Tₚₒₗₗ. In one embodiment, Tₚₒₗₗ is equal to approximately 1.0 s. The polling period Tₚₒₗₗ includes a plurality of transmitted polling signals and a receive time period. Each of the transmitted polling signals are spaced by a quiet time period in which no transmission takes place.

FIG. 6 depicts an enlarged view of a portion of polling signal process of FIG. 5 to show detail of a polling packet 610. The wireless device 12 is configured to transmit each data packet 610 during a transmission phase (“Tx”) 612, and then monitor for the receipt of a response signal from a vehicle transceiver during a reception phase (“Rx”) 614. Then the wireless device 12 is configured to turn off for a time period until the process repeats. This off time period can be most of the period Tₚₒₗₗ. In an example, the off time period can be about 90% of the period Tₚₒₗₗ or less than 95% and greater than half the polling period Tₚₒₗₗ. Each data packet 610 includes a plurality of pre-transmission polling signals 616 and a final transmission polling signal 618, that are transmitted at a set packet-poll period (T_{packet}_{_{—}}ₚₒₗₗ) and over a packet-poll time duration (TIME_{packet}_{_{—}}ₚₒₗₗ). The packet-poll time duration (TIME_{packet}_{_{—}}ₚₒₗₗ) can be equal to the polling period Tₚₒₗₗ minus the receive time period 614. In an example, the packet-poll period (T_{packet}_{_{—}}ₚₒₗₗ) and the packet-poll time duration (TIME_{packet}_{_{—}}ₚₒₗₗ) are both predetermined. The polling signal includes a preamble, a synchronization portion and a data portion according to one or more embodiments. In an example, the pre-transmission polling signals 616 are equally spaced in the TIME_{packet}_{_{—}}ₚₒₗₗ. The pre-transmission polling signals 616 have an equal time T_{packet}_{_{—}}ₚₒₗₗ.

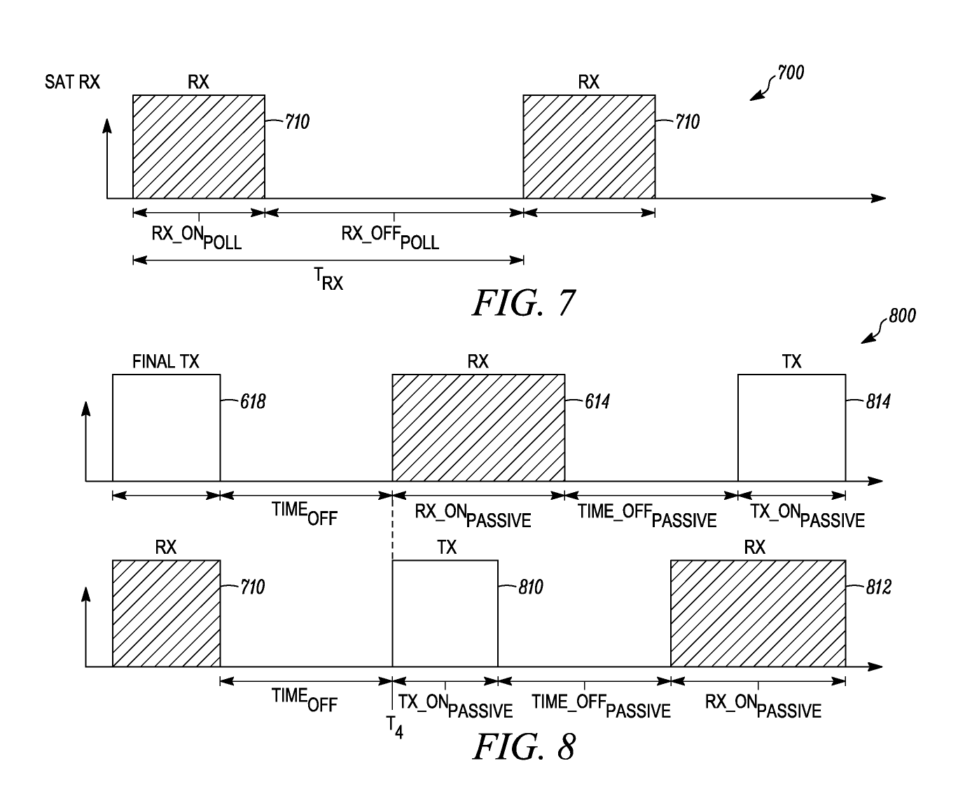

FIG. 7 depicts the manner in which at least one of the base stations 14, 16 monitors for the receipt of a polling signal from the wireless device 12 in accordance with an embodiment, and is generally referenced by numeral 700. The base stations 14, 16 operate in a reception on time at a time period (Tᵣₓ) that is greater than Tₚₒₗₗ. In one embodiment, Tᵣₓ is equal to approximately 1.2 s and Tₚₒₗₗ is about one second.

The polling operation 700 occurs automatically without the user affirmatively pressing a button on the wireless device 12. In one or more embodiments, only one of the base stations 14, 16 performs the polling operation 700 to further conserve energy. When the one base station confirms the polling signal, it can turn on the other base stations to begin communication with the wireless device 12. The receiver of the base station 14, 16 is initially off (indicated by low amplitude on Y axis) and then is configured to turn on (Rx_ONₚₒₗₗ) for a predetermined time to receive a polling signal from the wireless device 12. Rx_ONₚₒₗₗ is referenced by numeral 710. The process then repeats with the receiver turning off (Rx_OFFₚₒₗₗ) for a predetermined time before turning on again. In the illustrated polling operation 700, Rx_OFFₚₒₗₗ is greater than Rx_ONₚₒₗₗ. The turn on time period (Rx_ONₚₒₗₗ) is greater than the packet-poll period (T_{packet}_{_{—}}ₚₒₗₗ). In an example, the turn on time period (Rx_ONₚₒₗₗ) is less than the packet-poll time duration (TIME_{packet}_{_{—}}ₚₒₗₗ). In another example, the turn on time period (Rx_ONₚₒₗₗ) is greater than the packet-poll time duration (TIME_{packet}_{_{—}}ₚₒₗₗ).

The base stations 14, 16 are configured to operate in a reception on time (Rx_ONₚₒₗₗ) that is greater than T_{packet}_{_{—}}ₚₒₗₗ, and turn off (Rx_OFFₚ₀₁₁) for a period of time that is less than TIME_{packet}_{_{—}}ₚₒₗₗ. For example, in an embodiment Rx_ONₚₒₗₗ is between 17-27 ms, and T_{packet}_{_{—}}ₚₒₗₗ is between 15-25 ms; and Rx_OFFₚₒₗₗ is between 53-63 ms and TIME_{packet}_{_{—}}ₚₒₗₗ is between 56-66 ms. Such a configuration of the signals conserves energy and ensures there is overlap between the polling signals and the reception time such that a polling operation can be completed between the wireless device 12 and the vehicle.

FIG. 8 is a timing scheme depicting passive communication between the wireless device 12 and the base stations 14, 16, and is generally reference by numeral 800. After transmitting the final polling signal 618, the wireless device 12 turns off for a predetermined period of time (TIME_{off}) before monitoring for the receipt of a response signal during Rₓ phase 614. After the base station receives the final polling signal 618, it also turns off for the same predetermined period of time (TIME_{off}) before transmitting a passive signal 810. The wireless device 12 and the base station 14, 16 are now synchronized and begin communicating passively, at time (t₄). In one or more embodiments, all of the base stations 14, 16 are awake during passive communication. The base station 14, 16 transmits passive signal 810 for a predetermined time (TX_ONₚₐₛₛᵢᵥₑ), then turns off for a predetermined time (TIME_OFFₚₐₛₛᵢᵥₑ), then monitors for receipt of a passive signal from the wireless device 12 for a predetermined period of time (RX_ONₚₐₛₛᵢᵥₑ) during an Rx phase 812.

Upon receiving a response signal from a base station 14, 16 during the Rx phase 614, the wireless device 12 then enters a “passive function” communication operation with the base station. The RX phase 614 continues for a predetermined period of time (RX_ONₚₐₛₛᵢᵥₑ) during a Rx phase 812. The wireless device 12 then turns off for a predetermined time (TIME_OFFₚₐₛₛᵢᵥₑ) and then transmits a passive signal 814 for a predetermined time (TX_ONₚₐₛₛᵢᵥₑ).

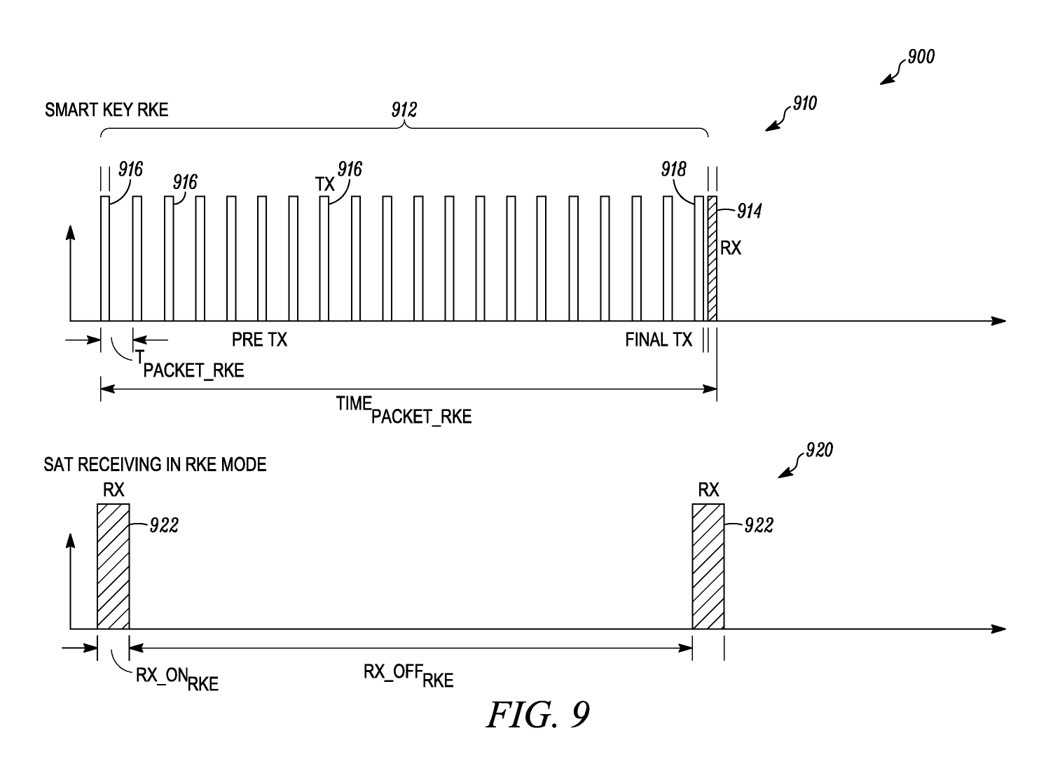

FIG. 9 depicts a timeline in which the wireless device 12 and the base stations 14, 16 communicate in response to operator initiated communication is illustrated in accordance with one or more embodiments, and is generally represented by numeral 900. Here, upon the operator activating the wireless device (e.g., by pressing a button), the wireless device 12 transmits a communication signal and then is configured for a period of time to receive a response signal from the transceiver. Such operator initiated communication is associated with the remote keyless entry (“RKE”) functionality of the PEPs system and is referenced by “RKE” in FIG. 9.

This method also works with the wireless device 12 being activated by an accelerometer that detects movement or certain defined movements of the wireless device.

The wireless device 12 is configured to transmit a data packet 910 during a transmission phase (“Tx”) 912, then monitor for receipt of a response signal from a vehicle transceiver during a reception phase (“Rx”) 914.

Each data packet 910 includes a plurality of polling signals, including a plurality of pre Tx signals 916 and a final Tx signal 918 that are transmitted at a predetermined time period (T_{packet}_{_{—}}ᵣₖₑ) and over a predetermined time duration (TIME_{packet}_{_{—}}ᵣₖₑ). The time duration (TIME_{packet}_{_{—}}ᵣₖₑ) can be set to about one second. In this embodiment, the number of polling transmission signals is greater than that shown in the embodiment of FIG. 5. In an example, the time period (T_{packet}_{_{—}}ᵣₖₑ) is about 1/20^{th} the time duration (TIME_{packet}_{_{—}}ᵣₖₑ). The polling transmission signal has a time duration of about 2% to 10% of the time period (T_{packet}_{_{—}}ᵣₖₑ). In an embodiment, transmission signal has a time duration of about 2% to 5% of the time period (T_{packet}_{_{—}}ᵣₖₑ) or about 2% to 4% of the time period (T_{packet}_{_{—}}ᵣₖₑ).

FIG. 9 also depicts the manner in which the base stations 14, 16 monitor for the receipt of an RKE communication signal from the wireless device in accordance with one embodiment, and is generally referenced by numeral 920. The receiver of the base station is initially off (indicated by low amplitude on Y axis) and then is configured to turn on (Rx_ONᵣₖₑ) for a predetermined time to receive a communication signal from the wireless device 12, which is referenced by numeral 922. The process then repeats with the receiver turning off (Rx_OFFᵣₖₑ) for a predetermined time before turning on again. In one or more embodiments, the main base station 14 does not include the internal transceiver 82 and does not perform such RKE communication with the wireless device 12.

The base stations 14, 16 are configured to operate in a reception on time (Rx_ONᵣₖₑ) that is greater than T_{packet}_{_{—}}ᵣₖₑ, and turn off (Rx_OFFᵣₖₑ) for a period of time that is less than TIME_{packet}_{_{—}}ᵣₖₑ. For example, in one embodiment Rx_ONᵣₖₑ is between 5-9 ms, and T_{packet}_{_{—}}ᵣₖₑ is between 3-7 ms; and Rx_OFFᵣₖₑ is between 91-95 ms, and TIME_{packet}_{_{—}}ᵣₖₑ is between 94-98 ms. Each base station remains awake in Rx mode until receipt of the Final Tx signal 718. Upon receiving the Final Tx signal 918, the base station turns off for a predetermined time. The communication signal includes a preamble, a synchronization portion and a data portion according to one or more embodiments.

The present disclosure describes a polling processes and systems. Polling, in an example, may be the process where an electronic device (e.g., a controlling device) waits for an external device to check for its readiness or state. This can be done with relatively low-level hardware. These processes can include reading an encrypted signal or reading a simple digital signal to begin a communication session between the two devices. Polling may include busy-wait polling. Polling may also include when an external device is repeatedly checked for readiness, and if it is not ready or present, the electronic device (e.g., a computing system in a vehicle) returns to a different task.

As such, existing polling methods typically maintain the receiver of the wireless device in an on state during polling. Such methods discharge the battery of the wireless device quickly, especially when the devices are communicating within the UWB bandwidth. The presently disclosed polling method repeatedly turns off the wireless device during polling to extend the charge of the battery of the wireless device.

Examples of the polling system can include a wireless, polling device for communicating with a vehicle. The polling device can include a controller to produce a polling signal with a transmission period, a receive period and a sleep period with the sleep period being longer than the transmission period and receive period combined and the transmission period and sleep period together being longer than a receive period of a vehicle. The polling device can include a transceiver connected to the controller and configured to transmit the polling signal from the device or to receive a vehicle signal at the device. In an example, the controller configured to produce the polling signal during a polling time period. The polling signal includes a plurality of time separated, polling transmission signals and a receive time period. The polling transmission signals can be separated by a non-transmission time period that is greater than a transmission time of the time separated transmission signals. The controller can repeat the polling signal until the controller receives a poll response signal from a vehicle. In an example, the receive time period is about the same as the transmission time period. In an example, the receive time period is a single receive time period after the plurality of the time separated, polling transmission signals.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

I claim:

1. A wireless, polling device for communicating with a vehicle comprising:
a controller to produce a polling signal with a transmission period, a receive period and a sleep period with the sleep period being longer than the transmission period and receive period combined and the transmission period and sleep period together being longer than a receive period of a vehicle; and
a transceiver connected to the controller and configured to transmit the polling signal from the device or to receive a vehicle signal at the device.

2. The device of claim 1, wherein the controller configured to produce the polling signal during a polling time period, wherein the polling signal includes a plurality of time separated, polling transmission signals and a receive time period,
wherein the polling transmission signals are separated by a non-transmission time period that is greater than a transmission time of the time separated transmission signals, and
wherein the controller repeats the polling signal until the controller receives a poll response signal from a vehicle.

3. The device of claim 2, wherein the receive time period is about the same as the transmission time period.

4. The device of claim 2, wherein the receive time period is a single receive time period after the plurality of the time separated, polling transmission signals.

5. The device of claim 4, wherein the non-transmission time period is greater than ten times the transmission time period.

6. The device of claim 5, wherein the transceiver is configured to transmit the polling signal at a frequency of greater than or equal to 2.4 GHz.

7. The device of claim 2, wherein the plurality of time separated transmission polling signals includes four or more transmission polling signals for each receive time period.

8. The device of claim 2, wherein the plurality of time separated transmission polling signals includes four or more transmission polling signals for each receive time period.

9. A short range polling system comprising:
a portable device including:
a controller to produce a polling signal with a transmission period, a receive period and a sleep period with the sleep period being longer than the transmission period and receive period combined and the transmission period and sleep period together being longer than a receive period of a vehicle, and
a transceiver connected to the controller and configured to transmit the polling signal from the device or to receive a vehicle signal at the device; and
a vehicle with a communication system configured to have a polling signal receive time period greater than a sum of a non-transmission, polling time period and the transmission time of the time separated transmission signals.

10. The system of claim 9, wherein the controller configured to produce the polling signal during a polling time period, wherein the polling signal includes a plurality of time separated, polling transmission signals and a receive time period,
wherein the polling transmission signals are separated by a non-transmission time period that is greater than a transmission time of the time separated transmission signals, and
wherein the controller repeats the polling signal until the controller receives a poll response signal from the vehicle.

11. The system of claim 10, wherein the receive time period is about a same time as the transmission time period.

12. The system of claim 11, wherein the controller determines position of the portable device relative to the vehicle after receiving signals from the vehicle.

13. The system of claim 9, wherein the vehicle includes a receive time off period that is less than or equal to twice a time period (T_{packet-poll}) of a single transmit time period and a single non-transmission, polling time period.

14. The system of claim 9, wherein the controller receives a response signal from the vehicle and enters a passive communication operation and ends the polling signal.

15. The system of claim 9, wherein the controller turns off the transceiver after a final polling signal of plurality of time separated, polling transmission signals for a first time off period and then turns the transceiver to a receive mode after the first time off period and wherein a passive communication operation begins after a second time off period.

16. The system of claim 15, wherein the second time off period is greater than the first time off period.

17. A wireless polling method between a base station and a mobile device, comprising:
transmitting a polling signal including a plurality of time separated, polling transmission signals and a final polling transmission signal that is at an end of the plurality of polling transmission signals;
monitoring for a poll response signal after transmitting the polling signal with a single receive period for each transmitting of the polling signal;
if the poll response is not received in the receive period, then waiting a first time period and thereafter transmitting the polling signal again; and
if the poll response is received in the receive period, then waiting a second time period and thereafter entering a passive communication mode.

18. The method of claim 17, wherein transmitting includes separating polling the transmission signals by a third time period that is greater than a transmission signal time period of the polling transmission signals.

19. The method of claim 18, wherein the third time period is ten times greater than the transmission signal time period.

20. The method of claim 17, wherein a vehicle includes a polling signal receive time period greater than a sum of the third time period and the transmission time of the transmission signal time period; and wherein transmitting includes transmitting four or more transmission polling signals for each receive period.
